(19) United States
(12) Patent Application Publication
(10) Pub. No.: US 2026/0055547 A1
(43) Pub. Date: Feb. 26, 2026

(54) WATER-EXTRACTING PRESS FOR EXTRACTING WATER FROM LAUNDRY

(71) Applicant: Herbert Kannegiesser GmbH, Vlotho (DE)

(72) Inventors: Jürgen HILDEBRAND, Hildesheim (DE); Engelbert HEINZ, Vlotho (DE)

(73) Assignee: Herbert Kannegiesser GmbH, Vlotho (DE)

(21) Appl. No.: 19/304,296

(22) Filed: Aug. 19, 2025

(30) Foreign Application Priority Data
Aug. 20, 2024 (DE) 10 2024 123 686.8

(51) Int. Cl. D06F 47/04

(52) U.S. Cl. CPC D06F 47/04

(57) ABSTRACT

A water-extracting press by way of which the laundry is treatable in a time- and energy-efficient manner and space-saving manner. This is achieved in that a water-extracting press for extracting water from laundry has a press basket for receiving the laundry and has a press ram which is movable up and down by at least one hydraulic cylinder and, during the downward movement, is movable from above into the press basket. Moreover, the hydraulic cylinder is arranged in a press cylinder. Furthermore, the water-extracting press includes a main cylinder and a pressure intensifier, wherein the main cylinder and the pressure intensifier are integrated into the press cylinder.

The invention relates to a water-extracting press as per the preamble of claim 1. The invention furthermore relates to a water-extracting press as per the preamble of claim 12 and to a water-extracting press as per the preamble of claim 14.

Laundry passes through various treatment steps in industrial laundries. After the laundry has been washed in a washing machine, it is necessary, for further treatment, for the liquid left, which is referred to as bound liquor, to be removed from the laundry. For this purpose, the laundry is fed to a water-extracting device, such as a centrifuge or a water-extracting press. In the water-extracting device, in particular in the water-extracting press, the laundry is not just separated from the bound liquor, but rather can additionally also be rinsed in the press before the water-extraction takes place.

In the case of a water-extracting press for extracting water from the laundry, this is integrated in a press basket. Above said press basket, there is arranged on columns a lifting cylinder or hydraulic cylinder, which has a press ram by way of which water is extracted from the laundry in the press basket. A compacted mass of laundry is formed by the laundry being pressed together in the press basket, which compacted mass of laundry, for the subsequent treatment steps, has to be separated.

Water-extracting press themselves take up a relatively large amount of space. This is due on the one hand to the fact that, for each water-extraction process, the largest possible quantity of laundry is to be treated, but on the other hand also to the extremely high pressures, which require a high degree of stability of the individual components and therefore a very solid construction. Since the available space is limited, in particular including in laundries, relatively large installations prove to be too space-intensive or problematic.

For rapid extraction of water from the laundry in a water-extracting press, hydraulic cylinders with a maximum internal pressure of approximately 350 bar are used. A force which acts on the laundry and causes water to be extracted from the latter is generated according to the area ratio of the piston-surface area of the hydraulic cylinder to the piston-rod area. The greater the force acting on the laundry, the smaller the amount of residual moisture in the laundry, which has to be evaporated in a dryer at a later stage. Thus, if the amount of residual moisture in the press can be reduced, the result overall is an energy saving with regard to the treatment of the laundry. However, a further reduction in the amount of residual moisture is possible only by increasing the pressure, for which purpose the known water-extracting presses would have to have greater dimensions.

A further disadvantage of known water-extracting presses is that, for the purpose of building up pressure, use is made of axial piston pumps with constant rotational speeds. The use of these pumps limits the speed at which pressure is built up, which inevitably results in a short water-extraction duration in comparison with the total cycle of the piston movement. Furthermore, high current peaks are generated, whereby the entire water-extraction process proves to be extremely energy-intensive. The use of known water-extracting presses therefore proves to be highly time-consuming and costly.

Taking these disadvantages as a starting point, the present invention is based on the object of providing a water-extracting press by way of which the laundry is treatable in a time- and energy-efficient manner and space-saving manner.

A solution to this problem is described by Claim 1. Accordingly, it is provided that the water-extracting press for extracting water from laundry has a press basket for receiving the laundry and has a press ram which is movable up and down by at least one hydraulic cylinder and, during the downward movement, is movable from above into the press basket. Moreover, the hydraulic cylinder is arranged in a press cylinder. Furthermore, the invention makes provision for the water-extracting press to have a main cylinder and a pressure intensifier, wherein the main cylinder and the pressure intensifier are integrated into the press cylinder. While the main cylinder is comparable with the known cylinder for extracting water from the laundry, the pressure intensifier is a component with which the pressure exerted on the laundry for the purpose of water-extraction can be increased. Since this additional pressure intensifier is integrated into the press cylinder, there is only an insignificant change to the size or dimensions of the water-extracting press. It is accordingly possible for a higher pressure to be exerted on the laundry with the press ram unchanged, specifically without there being, in order to realize this, an increase in the size of the water-extracting press. It is equally conceivable that, for a hydraulic pressure identical in comparison with known water-extracting presses, the size of the press can be reduced by making use of the pressure intensifier.

Preferably, it is moreover provided that the pressure intensifier comprises at least one hydraulic cylinder. This at least one further hydraulic cylinder can be integrated into the existing hydraulic system of the water-extracting press without any problems. Due to the axial design of the press cylinder, the at least one additional hydraulic cylinder can also be readily incorporated into the existing design without the need for relatively major conversion measures in the process.

In particular, it is provided that the pressure intensifier comprises at least two, three or more hydraulic cylinders. These ideally two or three hydraulic cylinders are correspondingly mutually connected and controllable. In terms of their dimensioning, they are preferably identical and smaller than the main cylinder.

A particularly preferred exemplary embodiment of the invention provides that a piston area of the at least one hydraulic cylinder of the pressure intensifier is smaller than a piston area of the main cylinder. In particular, it is provided that the piston area of the hydraulic cylinder of the pressure intensifier is between 1/10 and ½, preferably ⅕ and ⅖, in particular is ⅓, of the piston area of the main cylinder. As a result of this reduction in the piston area, with the force acting on the cylinder unchanged, the internal pressure increases from, for example the original, 350 bar to 500 bar (for an exemplary area ratio of 1:1.43). The at least one hydraulic cylinder is activated when the system pressure reaches for example the original maximum value of 350 bar. This subsequent use of further, smaller hydraulic cylinders proves to be particularly advantageous since, at the end of the pressing process, a very short cylinder stroke is sufficient to significantly reduce the amount of residual moisture under the elevated pressure of the cylinder.

Furthermore, it is preferably provided that the sum of the piston areas of the multiple, preferably of the two, three or more, hydraulic cylinders of the pressure intensifier is between 1/10 and ½, preferably ⅕ and ⅖, in particular is ⅓, of the piston area of the main cylinder. The use of multiple hydraulic cylinders allows them to be integrated in a particularly space-saving manner into the existing press cylinder. In particular, the dimensioning of the individual cylinders can be selected in such a way that they are well adapted to the existing conditions. Equally, selecting the number and the areas of the cylinders makes possible the provision of a pressure ratio that is suitable for a particularly efficient reduction in the amount of residual moisture.

Furthermore, it may preferably be provided that the multiple, preferably two, three or more, hydraulic cylinders of the pressure intensifier are arranged symmetrically and/or concentrically around a longitudinal axis of the press cylinder. Equally, the individual cylinders can particularly advantageously be coupled to the existing hydraulic system, in particular the inflows and outflows. Through the integration of the cylinders into the press cylinder, virtually no additional installation space is required for the water-extracting press, wherein at the same time the pressure to which the laundry is subjected for the purpose of water extraction is increased.

Preferably, it is provided that the press cylinder has at least two pressure chambers and at least two return chambers, specifically a pressure chamber and a return chamber of the main cylinder and in each case one pressure chamber and one return chamber for the hydraulic cylinder(s) of the pressure intensifier. In this case, it is in particular provided that the pressure chamber of the main cylinder is connected to the at least one return chamber for the hydraulic cylinder(s) of the pressure intensifier. As soon as the pressure intensifier is activated, that is to say the pressure in the return chamber of the hydraulic cylinder is built up, the pressure in the pressure chamber of the main cylinder also increases. Accordingly, the pressure exerted on the laundry also increases, whereby the amount of residual moisture can be reduced yet further.

The invention provides in particular that the pressure chamber and the return chamber of the main cylinder have in each case one valve, and the pressure chamber of the at least one hydraulic cylinder of the pressure intensifier likewise has a valve, via which an inflow and outflow of the hydraulic fluid are controllable. According to this embodiment, it is provided that, firstly, the pressure in the pressure chamber of the main cylinder is increased up to a maximum value via the corresponding valve. While this is happening, the valve for supply to the pressure chamber of the hydraulic cylinder is closed. As soon as the maximum pressure in the pressure chamber of the main cylinder is reached, the corresponding valve of the main cylinder is closed and the pressure is applied to the pressure chamber of the hydraulic cylinder. This pressure causes the hydraulic cylinder to increase the pressure in the pressure chamber of the main cylinder and thus also the pressure on the laundry. After completion of the water-extraction process, the valves are opened and both the main cylinder and the hydraulic cylinder are moved back into a starting position.

A specific exemplary embodiment of the invention may provide that the inflow and outflow are connected to at least one hydraulic pump.

A further solution to the problem stated at the outset is achieved by the features of claim 12. Accordingly, it is provided that a water-extracting press for extracting water from laundry has a drive for moving the at least one hydraulic cylinder up and down, wherein said drive is designed as a hydrodynamic servo pump. The use of the servo pump allows the movement of the hydraulic cylinder or main cylinder to be configured in a highly energy-efficient manner. Generally, little energy is required to start the press ram, and for this reason said movement is able to be carried out quite quickly by the servo drive or the servo pump. As soon as the press ram presses the laundry together and pressure is exerted on the laundry, less energy is required. Ultimately, the press ram need be held only in this position. This means that the pressure generated by the servo pump and thus the current load can be controlled according to the mechanical resistance exerted by the laundry on the press ram. While in known water-extracting presses, the hydraulic cylinder is permanently subjected to a large force, the application of pressure according to the present invention is realized according to the actual pressure exerted on the press ram. This saves both energy and time. This is because time can be saved in comparison with the previous technology, in particular as a result of the relatively quick movement of the press ram into the water-extraction position.

Preferably, it is moreover provided that the water-extracting press has two, three or four hydraulic cylinders, wherein each hydraulic cylinder has a hydrodynamic servo pump or is connected to a hydrodynamic servo pump.

A further solution to the stated problem is described by the features of claim 14. Accordingly, it is provided that a water-extracting press has both the features as claimed in at least one of claims 1 to 11 and the features as claimed in at least either of claims 12 and 13.

A preferred exemplary embodiment of the present invention will be discussed in more detail below on the basis of the drawing. In the drawing:

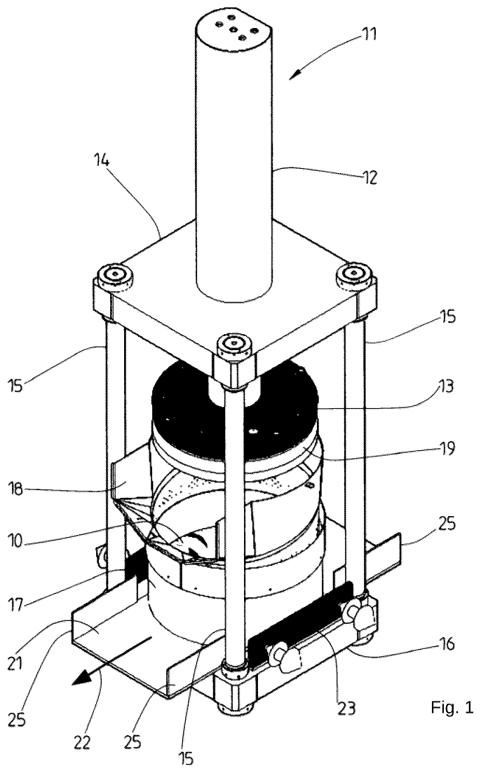

FIG. 1 shows a schematic illustration of a water-extracting press, and

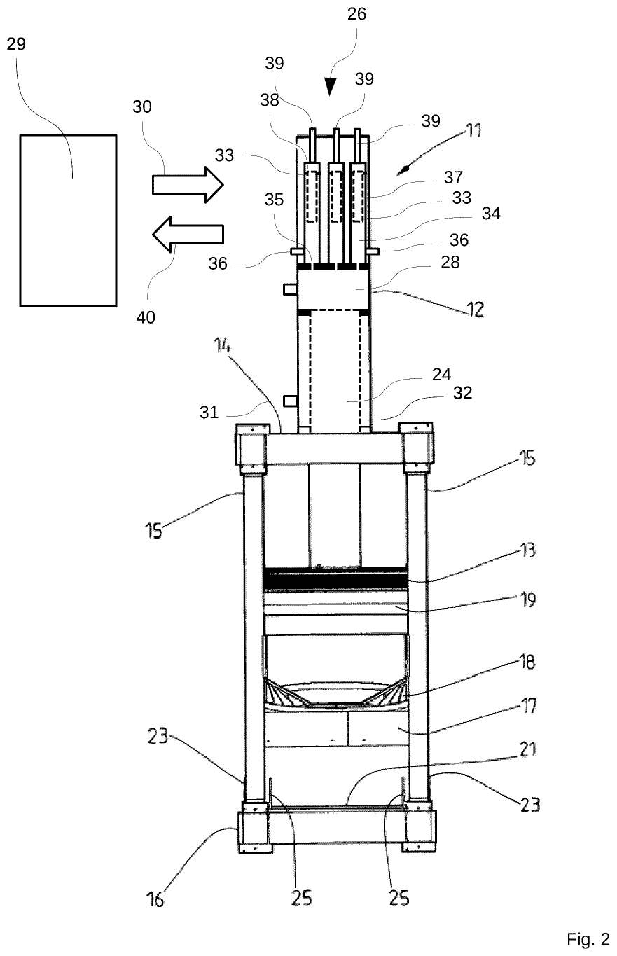

FIG. 2 shows a side view of the water-extracting press as per FIG. 1.

In industrial laundries, use is made of water-extracting presses 11 to remove a bound liquor from washed laundry 10. The water-extracting press 11 illustrated schematically in FIG. 1 has a press cylinder 12 in whose interior there is arranged a piston of a main cylinder 24 with a press ram 13. The press ram 13 can be moved up and down along the longitudinal axis of the press cylinder 12.

In the water-extracting press 11 according to the invention illustrated in FIG. 1, the press cylinder 12 is connected directly to columns 15 via a cylinder flange 14. In the exemplary embodiment illustrated here, the cylinder flange 14 is fastened to a column at each corner region. However, it is also conceivable that the cylinder flange 14 is fastened to fewer or more columns. The columns 15 are fastened on a plate 16 at an end situated opposite the cylinder flange 14. Said plate 16 serves as a standing element of the water-extracting press 11.

A press basket 17 is arranged in the interior space of the water-extracting press 11 defined by the columns 15. Said press basket 17 may be designed for example as a hollow cylinder and serves for receiving the laundry 10 from which water is to be extracted. In the exemplary embodiment illustrated here by way of example, an outer dimension or the diameter of the press basket 17 is greater than the distance between the columns 15. The press basket 17 therefore protrudes at its wall into the region of the columns 15. The press basket 17 illustrated here has a funnel-like loading aid 18 for easy and quick filling thereof with laundry 10.

The press basket 17 is positioned in the water-extracting press 11 in such a way that the press ram 13 can be lowered precisely into the press basket 17. By lowering the press ram 13 into the press basket 17 and by subjecting the laundry 10 to pressure by way of a membrane 19 which is arranged on the press ram 13, the bound liquor is pressed out of the laundry 10 so that a cylindrical compacted mass of laundry 20 is formed in the press basket 17.

In order to remove the compacted mass of laundry 20, firstly the press ram 13 is raised up from the compacted mass of laundry 20 and the press basket 17 is moved upward. The compacted mass of laundry 20 released in this way is then removed from the water-extracting press 11 in a removal direction 22 by a conveyor 21. The compacted mass of laundry 20 can be fed by the conveyor 21 to a further treatment device for further treatment. The conveyor 21 may be for example a belt conveyor or the like.

Since the diameter of the compacted mass of laundry 20 formed by the water-extracting press 11 described here is greater than the clear distance between the columns 15, the compacted mass of laundry 20 cannot be readily removed by the conveyor 21. In order for the compacted mass of laundry 20 to be able to pass between the columns 15, the compacted mass of laundry 20 is separated in the water-extracting press 11 by radial compression. Said radial compression is carried out by compression means 23. Said compression means 23 are designed as compression plates and are arranged between two columns 15 parallel to the removal direction 22 (FIG. 2). The compression means 23 are situated on two opposite sides of the compacted mass of laundry 20 and, in the exemplary embodiment illustrated here, are oriented parallel to one another.

For radial separation of the compacted mass of laundry 20, the compression means 23 may be moved by linear drives toward one another transversely to the pressing direction and removal direction 22. The compacted mass of laundry 20 situated between the compression means 23 is separated, and reduced in diameter, in such a way that it can be removed through the columns 15.

In order that the separated mass of laundry 20 does not get caught at the columns 15, or fall from the conveyors 21, when being removed from the water-extracting press 11, directing side walls 25 are assigned thereto. Said directing side walls 25 are also of plate-like form and may serve as an extension of the compression means 23. Preferably, such directing side walls 25 are assigned only to the columns 15 in the removal direction 22.

In order to further reduce the amount of residual moisture in the laundry 10, the pressure exerted on the laundry 10 must be increased further. For this purpose, the invention makes provision for the water-extracting press 11 to be supplemented by a pressure intensifier 26. Said pressure intensifier 26 makes it possible to increase the generatable pressure in such a way that the amount of residual moisture can be reduced significantly without any changes to the press ram 13. In this case, the pressure intensifier 26 is integrated into the press cylinder 12 so that, even structurally, only a few changes to the existing system are necessary or no additional installation space for the water-extracting press 11 is required.

FIG. 2 illustrates the water-extracting press 11 with the pressure intensifier 26 highly schematically. In this case, the pressure intensifier 26 and the related components are illustrated partly in a sectional illustration. It should be emphasized at this juncture that the figures serve merely for understanding and do not constitute a blueprint on which the requirements for a technical drawing are to be imposed.

The press cylinder 12 conventionally has the main cylinder 24. For the purpose of applying the required pressure to the laundry 10, hydraulic fluid is transported into a pressure chamber 28 via a valve 27. In this case, the hydraulic fluid is pressurized by a unit 29 (illustrated here merely schematically) and is conveyed through the valve 27 in the direction indicated by 30. Situated between the unit 29 and the press cylinder 12 are corresponding hydraulic hoses, which, for a better overview, are not however illustrated here.

By subjecting the pressure chamber 28 to the corresponding pressure, the main cylinder 24 is moved in the direction of the laundry 10 so that the press ram 13 is lowered onto the laundry 10 and extracts water from the latter. After completion of the water extraction, hydraulic fluid is transported equally into a return chamber 32 of the main cylinder 24 through a valve 31. This, too, is realized by the unit 29 via the hydraulic hoses not illustrated.

This conventional water-extraction process is now supplemented according to the invention by the effect of the pressure intensifier 26, specifically there being situated above the pressure chamber 28 three further structurally identical hydraulic cylinders 33 in the exemplary embodiment illustrated in FIG. 2 of the water-extracting press 11. Equally, it is conceivable that only one hydraulic cylinder 33 or two or more than three are situated above the pressure chamber 28. Equally, it is conceivable that these hydraulic cylinders 33 are not structurally identical, but rather are dimensionally different.

The individual hydraulic cylinders 33 likewise have a return chamber 34 in each case, said return chamber being connected via an opening 35 to the pressure chamber 28 of the main cylinder 24. During the build-up of pressure in the pressure chamber 28 of the main cylinder 24, the valves 36 connected to the return chambers 34 of the hydraulic cylinders 33 are closed. During this phase, the pistons 37 of the hydraulic cylinders 33 are in the starting position illustrated in FIG. 2, in which the volume of the return chambers 32 is at a maximum and the volume of the corresponding pressure chambers 38 of the individual hydraulic cylinders 33 is at a minimum. As soon as a maximum pressure is built up in the pressure chamber 28 of the main cylinder 24 by the unit 29, the valve 27 is closed, so that the pressure within the pressure chamber 28 is kept constant at least for a short time. Thereafter, the valves 39 of the pressure chambers 38 of the hydraulic cylinders 33 are opened, so that hydraulic fluid is transported into the pressure chambers 38 from the unit 29 via hydraulic hoses (likewise not illustrated). Due to the smaller piston areas of the hydraulic cylinders 33 in comparison with the main cylinder 24, with the force unchanged, there is an increase in the pressure which can be built up within the return chamber 34 or the pressure chamber 28 and thus also in the pressure which can be exerted by the press ram 13 on the laundry 10. This additional pressure on the laundry 10 is sufficient to significantly reduce the amount of residual moisture.

After completion of the water-extraction process, the hydraulic fluid is transported into the return chambers 32 and 34 through the valves 31 and 36 in the reverse direction, so that the hydraulic fluid is returned back into the unit 29 from the pressure chambers 28 and 38 in the direction indicated by 40. Omission of the valve 36 is conceivable. In this case, the hydraulic fluid flows from the pressure chamber 28 into the return chambers 34 through the openings 35 and pushes the pistons 37 upward so that the hydraulic fluid is returned from the pressure chambers 38 through the valves 39.

The transmission of pressure to the main cylinder 24 can be varied by varying the number and size and/or shape of the hydraulic cylinders 33. In this way, different dimensionings can be selected according to the design of the water-extracting press 11 and the requirements for the water extraction.

One particular exemplary embodiment of the invention may provide that the unit 29 is a hydrodynamic servo pump. Said servo pump generates and provides precisely the presently required pressure for hydraulic fluid to move the stated components of the main cylinder 24 and of the hydraulic cylinders 33. The servo pump therefore works dynamically and adapts the fluid pressure according to the working conditions. If a higher pressure is required, for example in the case of the pressure increase in the pressure chamber 28 or 38, the pump increases the pressure, whereby the cylinders are able to be moved into the water-extraction position more quickly due to the lack of opposing force. As soon as the maximum pressure in the stated chambers has been built up, the servo pump reduces its power in order to maintain the existing pressure for a certain period of time.

This reduction of the electrical power of the servo pump allows a considerable amount of electrical energy to be saved. A vane pump, a gear pump, a piston pump or the like are possible exemplary embodiments for said servo pump. These pumps are driven by a corresponding motor. Due to the aforementioned mode of operation, servo pumps are particularly energy-efficient and precise in terms of control, whereby the entire water-extraction process can be carried out in a highly time- and energy-efficient manner.

The valves 27, 31, 36, 39 stated here and the unit 29, which is preferably a servo pump, are controlled by a controller (not illustrated here). Pressures can be set according to the water-extraction process via said controller. The controller system regulates via the lines and valves the pressures within the pressure chambers, which can vary according to the fill level in the press basket 17 and the type of laundry. Use of the aforementioned servo pump allows the controller to respond to different water-extraction situations in a highly efficient manner.

Thus, by using the pressure intensifier 26 and additionally by using the servo pump, the space required for the water-extracting press 11 can be reduced and the entire process can be configured to be more time- and energy-efficient.

### LIST OF REFERENCE SIGNS

10 Laundry
11 Water-extracting press
12 Press cylinder
13 Press ram
14 Cylinder flange
15 Column
16 Plate
17 Press basket
18 Loading aid
19 Membrane
20 Compacted mass of laundry
21 Conveyor
22 Removal direction
23 Compression means
24 Main cylinder
25 Directing side wall
26 Pressure intensifier
27 Valve
28 Pressure chamber
29 Unit
30 Direction
31 Valve
32 Return chamber
33 Hydraulic cylinder
34 Return chamber
35 Opening
36 Valve
37 Piston
38 Pressure chamber
39 Valve
40 Direction

1. A water-extracting press for extracting water from laundry, having a press basket for receiving the laundry, having a press ram which is movable up and down by at least one hydraulic cylinder and, during the downward movement, is movable from above into the press basket, wherein the hydraulic cylinder is arranged in a press cylinder, characterized by a main cylinder and a pressure intensifier, wherein the main cylinder and the pressure intensifier are integrated into the press cylinder.

2. The water-extracting press as claimed in claim 1, wherein the pressure intensifier comprises at least one hydraulic cylinder.

3. The water-extracting press as claimed in claim 1, wherein the pressure intensifier comprises at least two, three or more hydraulic cylinders.

4. The water-extracting press as claimed in claim 1, wherein a piston area of the at least one hydraulic cylinder of the pressure intensifier is smaller than a piston area of the main cylinder.

5. The water-extracting press as claimed in claim 4, wherein the piston area of the hydraulic cylinder of the pressure intensifier is between 1/10 and ½, of the piston area of the main cylinder.

6. The water-extracting press as claimed in claim 3, wherein the sum of the piston areas of the multiple hydraulic cylinders of the pressure intensifier is between 1/10 and ½ of the piston area of the main cylinder.

7. The water-extracting press as claimed in claim 3, wherein the multiple hydraulic cylinders of the pressure intensifier are arranged symmetrically and/or concentrically around a longitudinal axis of the press cylinder.

8. The water-extracting press as claimed in claim 1, wherein the press cylinder has at least two pressure chambers and at least two return chambers, specifically a pressure chamber and a return chamber of the main cylinder and in each case one pressure chamber and one return chamber for the hydraulic cylinder(s) of the pressure intensifier.

9. The water-extracting press as claimed in claim 8, wherein the pressure chamber of the main cylinder is connected to the at least one return chamber for the hydraulic cylinder(s) of the pressure intensifier.

10. The water-extracting press as claimed in claim 8, wherein the pressure chamber and the return chamber of the main cylinder have in each case one valve, and the pressure chamber of the at least one hydraulic cylinder of the pressure intensifier likewise has a valve, via which an inflow and outflow of the hydraulic fluid are controllable.

11. The water-extracting press as claimed in claim 10, wherein the hydraulic inflow and hydraulic outflow of the hydraulic cylinder are connected to at least one hydraulic pump.

12. A water-extracting press for extracting water from laundry, having a press ram which is movable up and down by at least one hydraulic cylinder, and having at least one drive by which at least one hydraulic cylinder is movable up and down, as claimed claim 1, wherein the drive is a hydrodynamic servo pump.

13. The water-extracting press as claimed in claim 12, characterized by two, three or four hydraulic cylinders, wherein each hydraulic cylinder has a hydrodynamic servo pump.

14. A water-extracting press for extracting water from laundry, having a press basket for receiving the laundry, having a press ram which is movable up and down by at least one hydraulic cylinder and, during the downward movement, is movable from above into the press basket, wherein the hydraulic cylinder is arranged in a press cylinder as claimed in claim 1 and having a press ram which is movable up and down by at least one hydraulic cylinder, and having at least one drive by which at least one hydraulic cylinder is movable up and down, wherein the drive is a hydrodynamic servo pump.
